(19) United States
(12) Patent Application Publication
(10) Pub. No.: US 2009/0003488 A1
(43) Pub. Date: Jan. 1, 2009

(54) TRANSMITTER AND RECEIVER

(75) Inventor: Koichiro BAN, Kawasaki-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/036,723

(22) Filed: Feb. 25, 2008

(30) Foreign Application Priority Data
Mar. 8, 2007 (JP) 2007-58638

(51) Int. Cl. H04L 27/00

(52) U.S. Cl. 375/308; 375/329

(57) ABSTRACT

There is provided with a transmitter including: a modulator configured to modulate a data bit sequence by alternately using first and second signal point sets to generate a data symbol sequence; a data block generator configured to generate data blocks each including a plurality of data symbols, an addition unit configured to add a guard interval to each data block to generate data blocks with guard intervals; and a controller configured to control modulation by the modulator so that an end data symbol of a first data block with the guard interval and a head data symbol of a second data block with the guard interval generated following the first data block with the guard interval belong to different signal point sets and data symbols in the first and second data blocks with the guard interval alternately belong to the first and second signal point sets.

### CROSS REFERENCE TO RELATED APPLICATIONS

This application is based upon and claims the benefit of priority from the prior Japanese Patent Applications No. 2007-58638, filed on Mar. 8, 2007; the entire contents of which are incorporated herein by reference.

### BACKGROUND OF THE INVENTION

1. Field of the Invention

The present invention relates to a transmitter and a receiver, and for example, a transmitter using a modulation scheme such as π/2 shift BPSK (Binary Phase Shift Keying) modulation or π/4 shift QPSK (Quadri-Phase Shift Keying) modulation and a receiver which communicates with the transmitter.

2. Related Art

There is a method whereby a single carrier transmitter carries out transmission by adding a duplicate (copy) of a data symbol at the end of a block which is composed of a plurality of data symbols to the head of the block as a cyclic prefix and a receiver carries out frequency domain equalization (FDE). This method is called a “single carrier cyclic prefix (SC-CP) scheme.” FIG. 15 shows one configuration example of a transmitter using a conventional single carrier cyclic prefix scheme (SC-CP scheme).

First, modulator 101 converts a data bit sequence to a data symbol sequence. As the modulation scheme, a π/2 shift BPSK modulation scheme or π/4 shift QPSK modulation or the like is used. Each modulation scheme has two types of signal point sets and different signal point sets are used depending on whether a data symbol is odd-numbered or even-numbered. In the case of π/4 shift QPSK modulation, two data bits are converted to a one data symbol.

Next, assuming a plurality of data symbols outputted from a modulator 101 as one data block, a CP addition processing unit 102 copies an end part of the data block (one or a plurality of data symbols at the end) and adds the end part to the head of the data block as a cyclic prefix (CP). The data block with the cyclic prefix outputted from the CP addition processing unit 102 is converted at a D/A converter 103 from a digital signal to an analog signal and transmitted from an antenna 105 via an RF/IF transmission unit 104.

In this way, when the above described single carrier transmitter applies modulation using two types of signal point sets alternately, a zero point (origin of the IQ plane) may be passed by due to a transition between signal points across a boundary between data blocks with cyclic prefixes depending on the length of the cyclic prefix to be added to the data block, resulting in a problem that electric power efficiency degrades.

### SUMMARY OF THE INVENTION

According to an aspect of the present invention, there is provided with a transmitter comprising:

a modulator configured to modulate a data bit sequence by alternately using first and second signal point sets obtained by dividing a signal constellation on an IQ plane to generate a data symbol sequence;

a data block generator configured to generate data blocks each including a plurality of data symbols by dividing the data symbol sequence into a plurality,

an addition unit configured to add a duplicate of one or more data symbols at a head or an end of each data block to the end or the head of each data block as a guard interval (cyclic postfix or cyclic prefix) to generate data blocks with guard intervals;

a transmission unit configured to transmit the data blocks with the guard intervals; and

a controller configured to control modulation by the modulator so that
an end data symbol of a first data block with the guard interval and a head data symbol of a second data block with the guard interval generated following the first data block with the guard interval belong to different signal point sets and
   data symbols in the first data block with the guard interval alternately belong to the first and second signal point sets and data symbols in the second data block with the guard interval alternately belong to the first and second signal point sets.

According to an aspect of the present invention, there is provided with a transmitter comprising:

a modulator configured to modulate a data bit sequence by alternately using first and second signal point sets obtained by dividing a signal constellation on an IQ plane to generate a data symbol sequence;

a data block generator configured to generate data blocks each including a plurality of data symbols by dividing the data symbol sequence into a plurality,

a signal point conversion processor configured to
select a data block to be subjected to signal point conversion processing of converting the data symbols in the data block to signal points in a different signal point sets from the signal point sets that has used in the modulator and
perform the signal point conversion processing on a selected data block;

an addition unit configured to add a duplicate of one or more data symbols at a head or an end of each data block which is subjected or is not subjected to the signal point conversion processing to the end or the head of each data block as a guard interval (cyclic postfix or cyclic prefix) to thereby generate data blocks with guard intervals; and

a transmission unit configured to transmit the data blocks with guard intervals,

wherein the signal point conversion processor selects a first data block as a data block to perform the signal point conversion processing when a head data symbol of the first data block with the guard interval belongs to same signal point set as that of an end data symbol of a second data block with the guard interval generated preceding the first data block with the guard interval if the first data block is not subjected to the signal point conversion processing.

According to an aspect of the present invention, there is provided with a transmitter comprising:

a modulator configured to modulate a data bit sequence by alternately using first and second signal point sets obtained by dividing a signal constellation on an IQ plane to generate a data symbol sequence;

a data block generator configured to generate data blocks each including a plurality of data symbols by dividing the data symbol sequence into a plurality,

an addition unit configured to add a duplicate of one or more data symbols at a head or an end of each data block to the end or the head of each data block as a guard interval (cyclic postfix or cyclic prefix) to generate data blocks with guard intervals; and

a signal point conversion processor configured to
select a data block with the guard interval to be subjected to signal point conversion processing of converting the data symbols in the data block with the guard interval to signal points in different signal point sets from the signal point sets that has used in the modulator and
perform the signal point conversion processing on a selected data block with the guard interval;

a transmission unit configured to transmit the data blocks with the guard intervals which is subjected or is not subjected to the signal point conversion processing,

wherein the signal point conversion processor selects a first data block with the guard interval as a data block with the guard interval to perform the signal point conversion processing when a head data symbol of the first data block with the guard interval belongs to same signal point set as that of an end data symbol of a second data block with the guard interval generated preceding the first data block with the guard interval.

According to an aspect of the present invention, there is provided with a receiver comprising:

a reception unit configured to receive data blocks with guard intervals (cyclic prefixes or cyclic postfixes), each data block with guard interval including a plurality of data symbols;

an remover configured to remove the guard intervals from the data blocks with the guard intervals to extract the data blocks; and

a demodulator configured to demodulate data symbols included in each data block by alternately using two signal point sets obtained by dividing a signal constellation on an IQ plane,

wherein the demodulator uses same signal point set as the signal point set used for an end data symbol of a third data block preceding a fourth data block, for the head data symbol of the fourth data block when a symbol number of data symbols included in the guard interval is an odd number.

According to an aspect of the present invention, there is provided with a receiver comprising:

a reception unit configured to receive data blocks with guard intervals (cyclic prefixes or cyclic postfixes), each data block with the guard interval including a plurality of data symbols;

an remover configured to remove the guard intervals from the data blocks with the guard intervals to extract the data blocks;

a phase shifter configured to perform a phase shift on data symbols included in selection data blocks selected according to a predetermined selection pattern from among the data blocks; and

a demodulator configured to demodulate data symbols included in each data block which is subjected or is not subjected to the phase shift by the phase shifter, by alternately using two signal point sets obtained by dividing a signal constellation on an IQ plane.

### BRIEF DESCRIPTION OF THE DRAWINGS

FIG. 1 shows a first embodiment of a single carrier transmitter;

FIG. 2 shows an example of an input to or output from a CP addition processing unit in a conventional single carrier transmitter;

FIG. 3 shows signal points of a π/2 shift BPSK modulation scheme;

FIG. 4 shows signal points of a π/4 shift QPSK modulation scheme;

FIG. 5 shows an example of an input to or output from a CP addition processing unit according to the first embodiment of the single carrier transmitter;

FIG. 6 shows an example of operation when a postfix is added in the first embodiment of the single carrier transmitter;

FIG. 7 shows a second embodiment of a single carrier transmitter;

FIG. 8 shows an operation example of signal point conversion processing in the second embodiment of the single carrier transmitter;

FIG. 9 shows a third embodiment of a single carrier transmitter;

FIG. 10 is an operation example of the signal point conversion processing in the third embodiment.

FIG. 11 shows a first embodiment of a single carrier receiver;

FIG. 12 shows an operation example of the first embodiment of the single carrier receiver;

FIG. 13 shows a second embodiment of a single carrier receiver;

FIG. 14 shows an operation example of a second embodiment of a single carrier receiver; and

FIG. 15 shows a configuration example of a conventional single carrier transmitter.

### DETAILED DESCRIPTION OF THE INVENTION

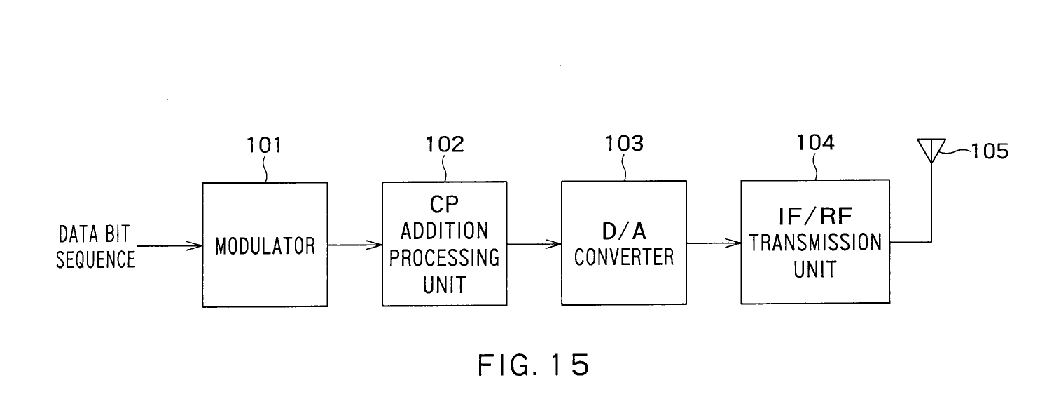

The present invention has been implemented to solve a problem independently discovered by the inventor in the conventional transmitter (see FIG. 15). Hereinafter, this problem will be explained in detail.

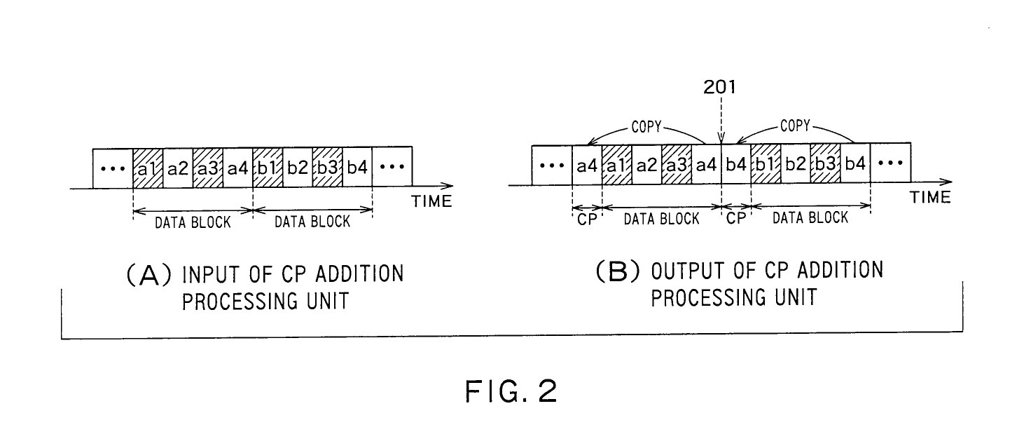

FIG. 2(A) and FIG. 2(B) show an example of the input and the output to/from the CP addition processing unit 102 in FIG. 15.

In FIG. 2(A), one cell denotes one data symbol and a1, a2, a3, a4, b1, b2, b3, b4 are data symbols respectively. In this example, one data block is composed of four data symbols. The CP addition processing unit 102 adds one symbol (a4 and b4) at the end of each data block to the head of each data block as shown in FIG. 2(B) as a cyclic prefix (CP). Since the receiver normally performs frequency domain equalization based on Fourier transform processing in data block units, if the number of data symbols in a data block is a power of 2, calculation efficiency of the Fourier transform is high. Hereinafter, suppose the number of data symbols in the data block is an even number.

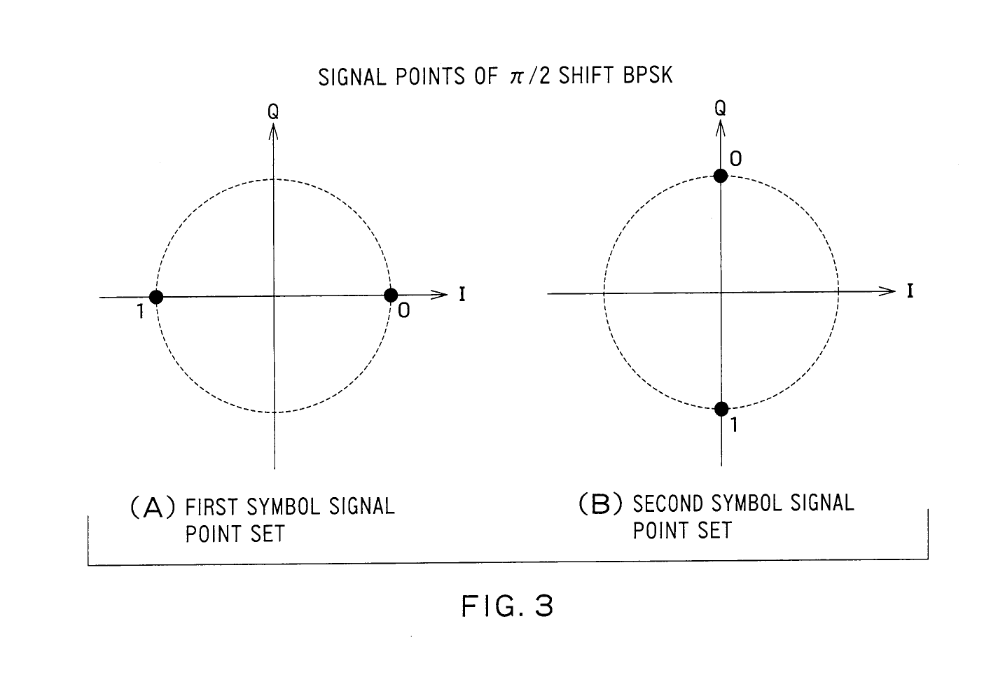

FIG. 3(A) and FIG. 3(B) show two types of signal point sets used for π/2 shift BPSK (Binary Phase Shift Keying) modulation. FIG. 3(A) shows a first symbol signal point set and FIG. 3(B) shows a second symbol signal point set. The first symbol signal point set in FIG. 3(A) and the second symbol signal point set in FIG. 3(B) correspond to first and second signal point sets which are obtained by dividing a signal constellation on an IQ plane.

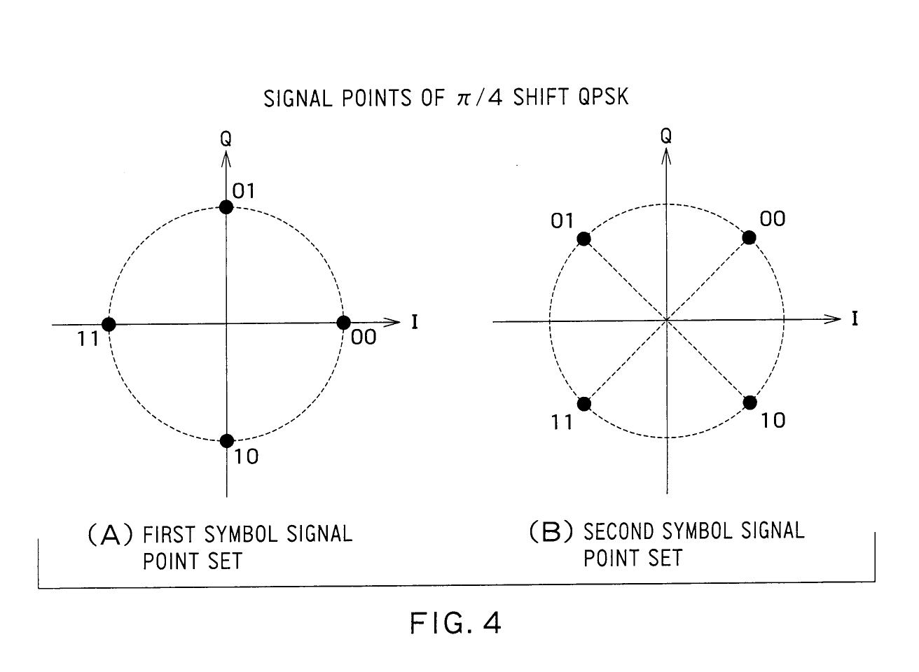

FIG. 4(A) and FIG. 4(B) show two types of signal point sets used for π/4 shift QPSK (Quadri-Phase Shift Keying) modulation. FIG. 4(A) shows a first symbol signal point set and FIG. 4(B) shows a second symbol signal point set. The first and second signal point sets in FIG. 4(A) and FIG. 4(B) correspond to first and second signal point sets which are obtained by dividing a signal constellation on an IQ plane.

Numbers next to respective signal points in FIG. 3(A), FIG. 3(B), FIG. 4(A), FIG. 4(B) mean their corresponding bits. As shown above, each modulation scheme has two types of signal point sets (first symbol signal point set and second symbol signal point set) and different signal point sets are used depending on whether a data symbol is odd-numbered or even-numbered. Generally, using two types of signal point sets alternately in this way prevents a zero point (origin of the IQ plane) from being passed by due to a transition between signal points and realizes transmission with high electric power efficiency. Hereinafter, suppose signal points which belong to the first symbol signal point set will be referred to as “first symbol signal points” and signal points which belong to the second symbol signal point set will be referred to as “second symbol signal points.” This embodiment will describe a case with π/2 shift BPSK modulation or π/4 shift QPSK modulation as an example of the modulation scheme, but it is obvious that the present invention is applicable to any modulation schemes other than these modulation schemes if they use two types of signal point sets alternately.

Suppose a case where π/2 shift BPSK modulation or π/4 shift QPSK modulation is applied to the modulator 101 of the conventional transmitter shown in FIG. 15.

At the output (input of the CP addition processing unit 102) of the modulator 101 shown in FIG. 2(A), the first symbol signal points in FIG. 3(A) or FIG. 4(A) are used for data symbols (a1, a3, b1, b3) in the shaded areas and the second symbol signal points in FIG. 3(B) or FIG. 4(B) are used for other data symbols (a2, a4, b2, b4). When one symbol at the end of a data block is added to the head as a cyclic prefix, as shown in FIG. 2(B), the same signal point set (second symbol signal point set) is repeatedly used across a boundary 201 between data blocks with cyclic prefixes and there is a possibility that a zero point may be passed by due to a transition between signal points. In this case, a variation in amplitude of a transmission analog waveform increases and power consumption of an amplifier increase, which produces such a problem that electric power efficiency deteriorates. That is, the conventional transmitter has a problem that depending on the length of a cyclic prefix added to a data block, the original purpose of improving electric power efficiency by using two types of signal point sets alternately cannot be achieved.

In view of the problem independently discovered by the inventor, this embodiment is intended to ensure data symbols across a boundary between two data blocks with cyclic prefixes always belong to different signal point sets irrespective of the lengths of the cyclic prefixes added to the data blocks.

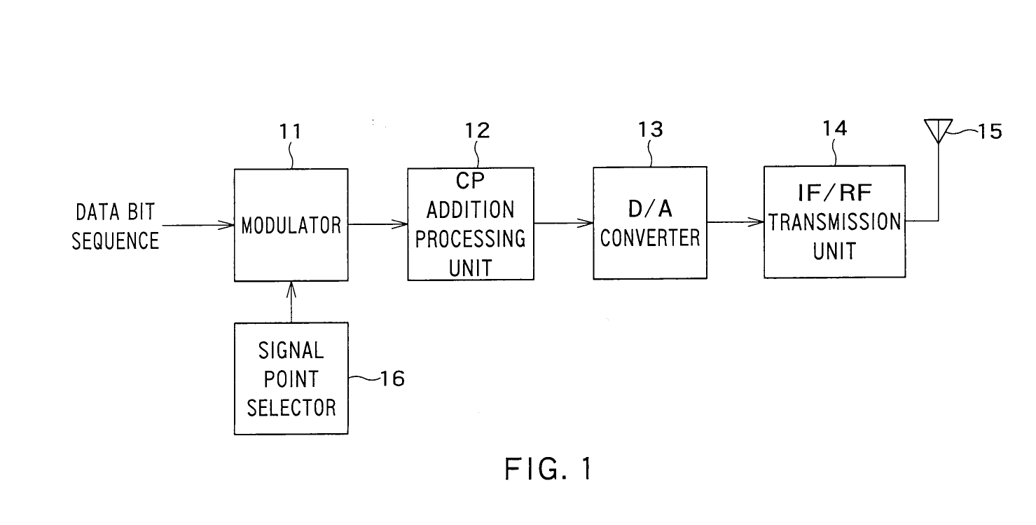

FIG. 1 shows a first embodiment of a single carrier transmitter of the present invention.

The modulator 101 of the conventional transmitter shown in FIG. 15 always uses a first symbol signal point set and a second symbol signal point set alternately, but in this first embodiment, signal point sets used by a modulator 11 are controlled by a signal point selector 16. The signal point selector 16 corresponds to, for example, a controller.

The modulator 11 generates a data symbol sequence by modulating a data bit sequence in units of a predetermined number of bits. For example, in the case of π/4 shift QPSK modulation, two data bits are converted to one data symbol. The signal point set (first or second signal point set) used for a conversion to a data symbol sequence is specified from the signal point selector 16. Assuming a plurality of data symbols outputted from the modulator 11 as one data block, a CP addition processing unit 12 copies (duplicates) an end part of a data block (one or a plurality of blocks at the end) and adds it to the head of the data block as a cyclic prefix (CP) or a guard interval. The data block with the cyclic prefix outputted from the CP addition processing unit 12 is converted from a digital signal to an analog signal at a D/A converter 13 and transmitted from an antenna 15 via an IF (Intermediate Frequency)/RF (Radio Frequency) transmission unit 14. Incidentally, the CP addition processing unit 12 includes a data block generator and an addition unit, wherein the data block generator generates data blocks each including a plurality of data symbols by dividing the data symbol sequence into a plurality and the addition unit adds a duplicate of one or more data symbols at an end of each data block to the head of each data block as a guard interval (cyclic prefix) to thereby generate data blocks with guard intervals (cyclic prefixes). The addition unit may add a duplicate of one or more data symbols at a head each data block to the end each data block as a guard interval (cyclic postfix) to thereby generate data blocks with guard intervals (cyclic postfix) and this details will be described later.

Hereinafter, more specific operations of the signal point selector 16 and the modulator 11 will be explained.

When a number of symbols to be added to a data block by the CP addition processing unit 12 is an odd number, the signal point selector 16 instructs the modulator 11 to use the same signal point set as that with the immediately preceding data symbol (data symbol at the end of the immediately preceding data block) as the signal point set of the head symbol of the data block.

For example, when a data symbol at the end of a (k−1)th data block is assumed to be a second symbol signal point, the head symbol of a kth data block is a second symbol signal point when the number of symbols of cyclic prefixes added is an odd number and is a first symbol signal point when the number of symbols of the cyclic prefix added is an even number as in the case of a normal modulation operation (first and second symbol signal point sets are used alternately). Symbols after the head symbol in the kth data block are processed in such a way that first symbol signal points and second symbol signal points are arranged alternately as in the case of normal π/2 shift BPSK or π/4 shift QPSK. That is, when the head symbol of the kth data block is a second symbol signal point, the second symbol is a first symbol signal point, the third symbol is a second symbol signal point, . . . , or conversely when a first symbol signal point is used as the head symbol, the second symbol is a second symbol point and the third symbol is a first symbol signal point, . . .

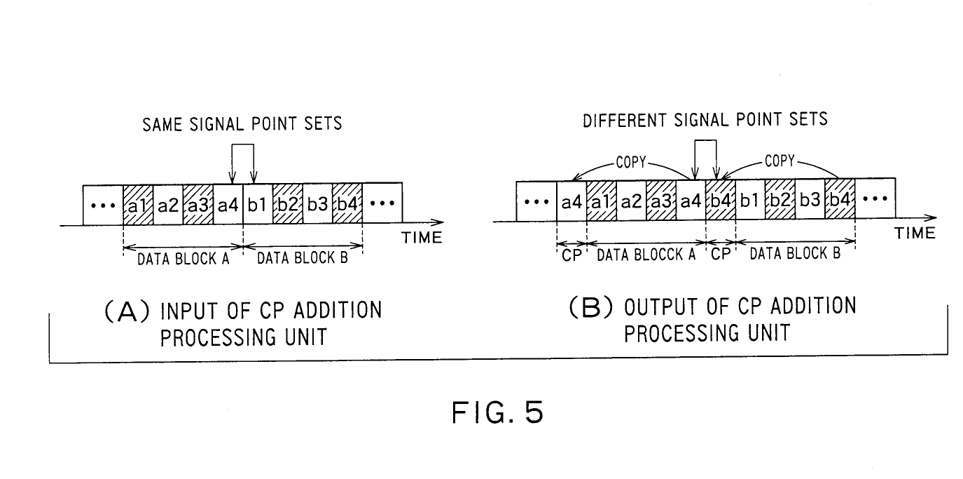

FIG. 5(A) shows an example of the input of the CP addition processing unit 12 (output of the modulator 11) in FIG. 1 and FIG. 5(B) shows an example of the output of the CP addition processing unit 12.

Symbols expressed by shaded areas denote first symbol signal points and symbols without shaded areas denote second symbol signal points. When attention is focused on a data block B, since the number of symbols of the cyclic prefix added is 1, that is, an odd number, a head symbol b1 of the data block B is processed by the modulator 11 so as to use the same first symbol signal point as the immediately preceding data symbol (end symbol of the data block of an immediately preceding data block A) a4. Applying such processing causes a first symbol signal point and a second symbol signal point to be used alternately at a joint between data blocks with cyclic prefixes at the output of the CP addition processing unit 12 as shown in FIG. 5(B) and allows signal points to be shifted correctly (without passing through a zero point). When, for example, the number of symbols is common to all data blocks and the length of cyclic prefix to be added is equally an odd number for all data blocks, a signal point set used as the head symbol of a data block is changed every one data block.

In the above described example, a data block is extended by adding a cyclic prefix (CP) to the head of the data block, but instead of this, it is also possible to extend a data block by copying the head part of the data block (one or a plurality of symbols at the head), adding it to the end of the data block, that is, by adding a cyclic postfix (hereinafter, abbreviated as “CS”) to the end of the data block. This also makes it possible to maintain a cyclic structure (cyclic structure of a waveform or data) of a data block and obtain effects equivalent to those of a cyclic prefix. The cyclic prefix and cyclic postfix are each called a “guard interval.”

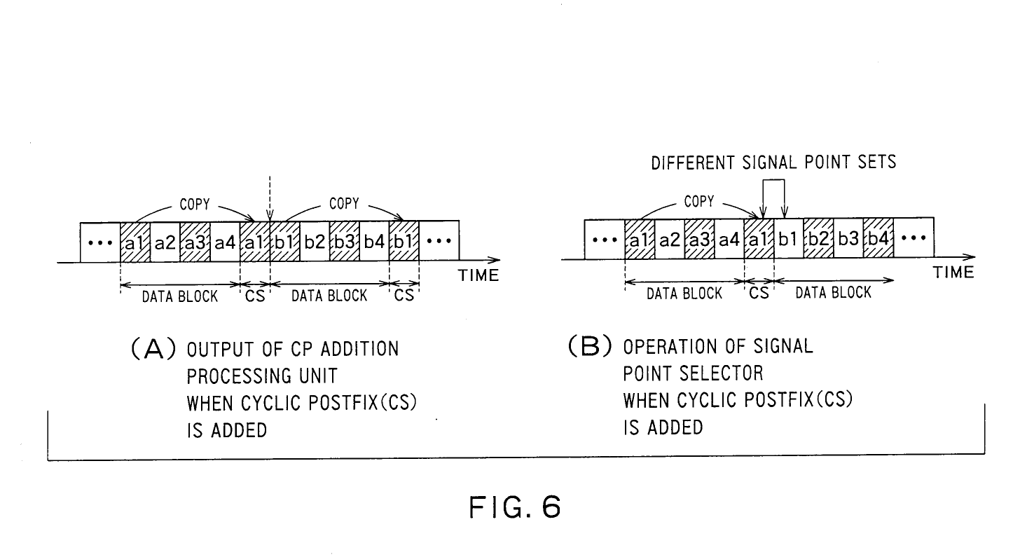

FIG. 6(A) shows an output example of the CP addition processing unit 102 when a cyclic postfix (CS) corresponding to one data symbol is added to the output (see FIG. 2(A)) of the modulator 101 of the conventional transmitter.

As shown in the figure, it is appreciated that when the number of symbols of a cyclic postfix (CS) added is an odd number, the same symbol signal point is used repeatedly across a boundary between data blocks with cyclic postfixes at the conventional transmitter.

FIG. 6(B) illustrates the operations of the signal point selector 16 and the modulator 11 when the CP addition processing unit 12 of the transmitter in FIG. 1 adds a cyclic postfix.

The signal point selector 16 instructs the modulator 11 to use a signal point set which is different from the data symbol (e.g., al in FIG. 6(B)) at the end of the preceding data block to which the CP addition processing unit 12 has added a cyclic postfix (CS) for the head symbol (e.g., b1 in FIG. 6(B)) of the data block. Performing such processing causes signal point sets to be correctly changed across a boundary between data blocks to which cyclic postfixes are added.

In the case of a cyclic postfix as well as the case of a cyclic prefix, when the number of symbols of all data blocks is the same and the length of a cyclic postfix added is equally an odd number for all data blocks, a signal point set used at the head symbol of a data block is changed for every one data block.

Since both the addition of a cyclic prefix and the addition of a cyclic postfix constitute processing of extending a data block in a cyclic structure, it is obvious that the two are equivalent if they are regarded as having changed the arrangement of data sequences. Therefore, a cyclic prefix will be used as an example in the following explanations, but it is obvious that the present invention is also applicable to the case with a cyclic postfix.

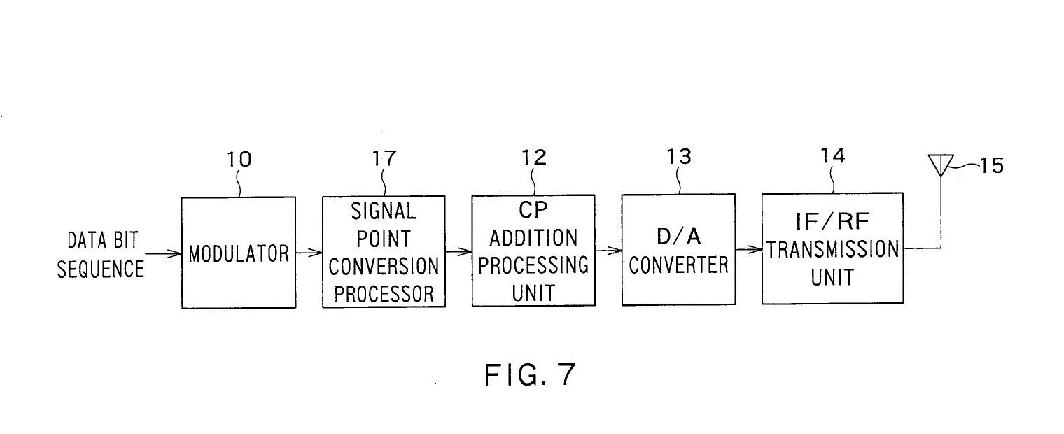

FIG. 7 shows a second embodiment of a single carrier transmitter of the present invention.

A difference from the first embodiment shown in FIG. 1 is that the signal point selector 16 has been removed and a signal point conversion processor 17 has been inserted after a modulator 10. The modulator 10 performs an operation similar to that of the modulator 101 of the conventional transmitter. That is, the modulator 10 performs modulation using a first symbol signal point set and a second symbol signal point set alternately for each symbol.

The newly added signal point conversion processor 17 changes, if necessary, all first symbol signal points and second symbol signal points in a data block which is made up of a plurality of data symbols. That is, the signal point conversion processor 17 performs signal point conversion processing of converting first symbol signal points to second symbol signal points and converting second symbol signal points to first symbol signal points.

As a first conversion method for converting signal points by the signal point conversion processor 17, a conversion is performed between a first symbol signal point and a second symbol signal point both meaning the same data. For example, in the case of π/4 shift QPSK in FIG. 4, “00” of the first symbol signal point and “00” of the second symbol signal point are mutually converted and “01” of the first symbol signal point and “01” of the second symbol signal point are mutually converted. This is equivalent to multiplying each data symbol in a data block by exp(jφ) and exp (−jφ) alternately. However, the amount of phase shift φ is π/2 radians with π/2 shift BPSK and π/4 radians with π/4 shift QPSK.

As a second conversion method for converting signal points by the signal point conversion processor 17, all data symbols in a data block are multiplied by exp(jφ). As for this second conversion method, unlike the first conversion method, when second symbol signal points are converted to first symbol signal points, data of the respective signal points are changed (the data are not changed in the case of conversions from first symbol signal points to second symbol signal points). For example, in the case of π/4 shift QPSK in FIG. 4, “00” of the first symbol signal point is converted to “00” of the second symbol signal point, whereas “00” of the second symbol signal point is converted to “01” of the first symbol signal point. However, no problem with data demodulation caused by a conversion of signal points will occur if the receiving side applies appropriate processing as will be described later.

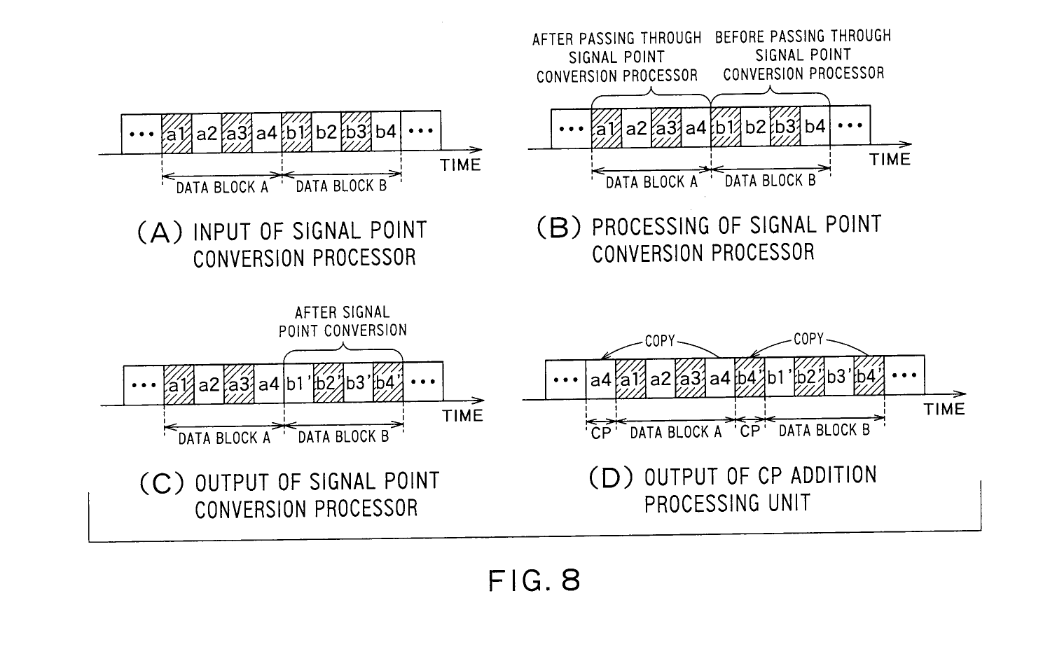

FIG. 8(A) to FIG. 8(D) illustrate the operation of the signal point conversion processor 17.

As shown in FIG. 8(A), before a signal is inputted to the signal point conversion processor 17, first symbol signal points (shaded) and second symbol signal points (not shaded) are arranged alternately. The signal point conversion processor 17 judges whether or not signal point conversion processing should be performed in data block units with reference to the length of cyclic prefix added and the signal point of the end symbol of the immediately preceding data block (data symbol immediately before the data block).

FIG. 8(B) shows a state in which a data block A has passed through the signal point conversion processor 17 before a data block B passes through the signal point conversion processor 17. Signal point conversion processing has not been applied to the data block A.

FIG. 8(C) shows a state after the data block B passes through the signal point conversion processor 17. Signal point conversion processing of switching round first symbol signal points and second symbol signal points is applied to the data block B. That is, when a data symbol (end symbol of the data block A after passing through the signal point conversion processor 17) a4 immediately before the data block B and a head symbol b1 of the data block B before passing through the signal point conversion processor 17 belong to different signal point sets and the length of a cyclic prefix added is an odd number (one in this example), the signal point conversion processor 17 performs signal point conversion processing to the data block B. “′” added to b1 to b4 indicate that the signal point conversion processor 17 has applied signal point conversion processing. Moreover, even when the data symbols a4 and b1 belong to the same signal point set and the length of a cyclic prefix added is an even number, the signal point conversion processor 17 also performs signal point conversion processing on the data block B. In any case, signal point conversion processing is applied for every other data block.

The CP addition processing unit 12 adds end symbols a4 and b4′ to their respective data blocks A and B which have passed through the signal point conversion processor 17 as cyclic prefixes (CP) as shown in FIG. 8(D).

In this way, this embodiment can prevent the same symbol signal point from being repeated across the boundary between data blocks to which cyclic prefixes are added. That is, it is possible to obtain a pattern in which a first symbol signal point and a second symbol signal point are always repeated.

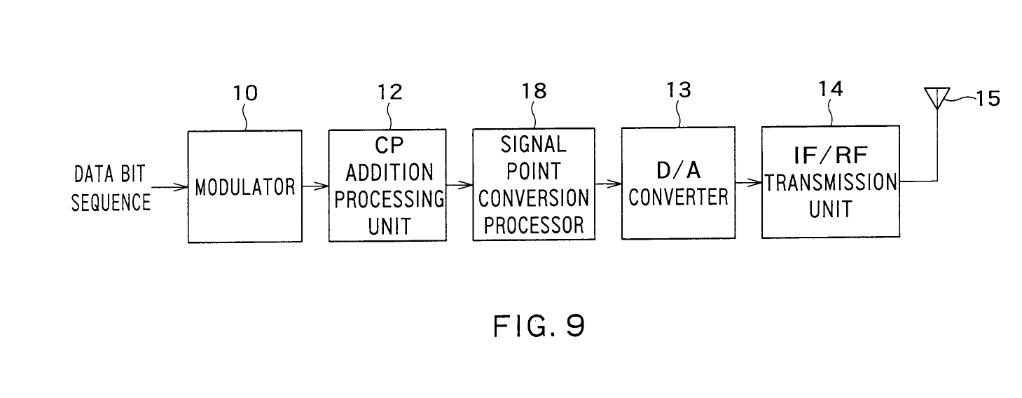

FIG. 9 shows a third embodiment of a single carrier transmitter of the present invention.

A difference from the second embodiment in FIG. 7 is that the signal point conversion processor is placed not before but after the CP addition processing unit 12. Therefore, a signal point conversion processor 18 of the third embodiment performs processing equivalent to that in the second embodiment on a cyclic prefix (CP) and a data block as a whole. That is, the signal point conversion processor 18 performs processing similar to that in the second embodiment on a data block with a cyclic prefix. In the third embodiment, processing up to output of the CP addition processing unit 12 is the same as that of the conventional transmitter shown in FIG. 15.

As in the case of the second embodiment, in the signal point conversion processing carried out by the signal point conversion processor 18, it is possible to use any one of a first conversion method whereby a conversion is performed between a first symbol signal point and a second symbol signal point meaning the same data and a second conversion method whereby all data symbols in data blocks with cyclic prefixes are multiplied by exp(jφ). However, a criterion as to whether or not to perform signal point conversion processing is different from that in the second embodiment as follows.

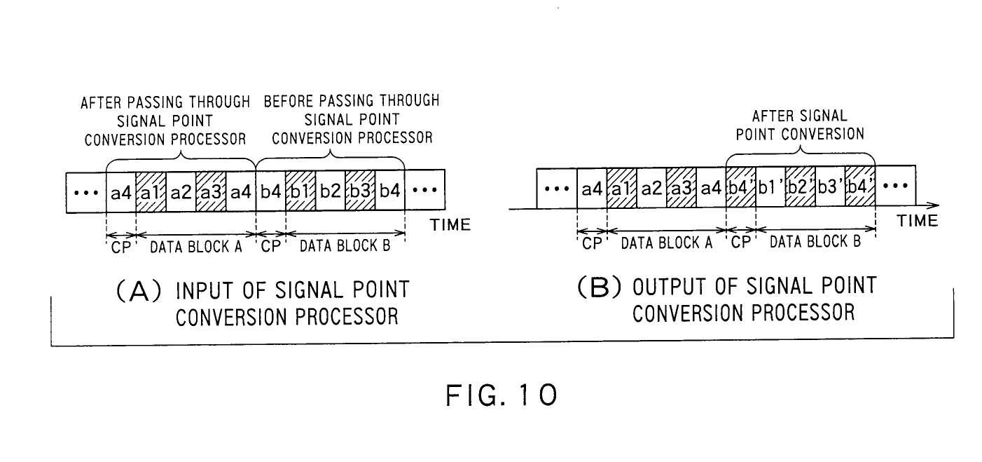

FIG. 10 illustrates the operation of the signal point conversion processor 18 in FIG. 9.

FIG. 10(A) shows a state in which a data block A with a cyclic prefix has passed through the signal point conversion processor 18 before a data block B with a cyclic prefix passes through the signal point conversion processor 18. No signal point conversion processing has been applied to the data block A with a cyclic prefix.

FIG. 10(B) shows a state after the data block B with a cyclic prefix passes through the signal point conversion processor 18. It is appreciated that signal point conversion processing has been applied to the data block B with a cyclic prefix. That is, as shown in FIG. 10(A), when the signal point of a head data symbol b4 of the data block B with a cyclic prefix (CP) and the immediately preceding data symbol, that is, the signal point of a data symbol a4 at the end of the data block A with a cyclic prefix belong to the same signal point set, signal point conversion processing using the above described first or second conversion method is performed on entire data block B with a cyclic prefix (CP) as shown in FIG. 10(B). In this way, a pattern in which a first symbol signal point and a second symbol signal point are always repeated can be obtained at the output of the signal point conversion processor 18.

Here, supplementary explanations will be given on respective operation standards of the signal point selector 16 in FIG. 1, the signal point conversion processor 17 in FIG. 7 and the signal point conversion processor 18 in FIG. 9.

It is obvious that if only a modulated signal point (first symbol signal point or second symbol signal point) of the head symbol of transmission data is determined beforehand, the respective operation standards can be uniquely determined depending on the size of a cyclic prefix (CP size) added to each data block that follows. The modulated signal point of the head symbol and the CP size of each block need to be shared between the transmitter and the receiver by being normally defined as the format of a transmission signal or being transmitted from the transmitter to the receiver beforehand. As the method of communicating the information (modulated signal point of the head symbol and the CP size of each block) from the transmitter to the receiver, a method of transmitting the information from the transmitter to the receiver as information to be reported or a method of transmitting the information from the transmitter to the receiver using a predetermined format of the transmission signal or the like may be considered.

As described above, applying the single carrier transmitter shown in the first to third embodiments makes it possible to prevent passage through a zero point due to a transition between signal points across a boundary between data blocks with cyclic prefixes irrespective of the number of symbols of cyclic prefixes added to the data blocks. Therefore, it is possible to reduce a variation width of the amplitude of a transmission signal and realize a single carrier transmitter with high electric power efficiency.

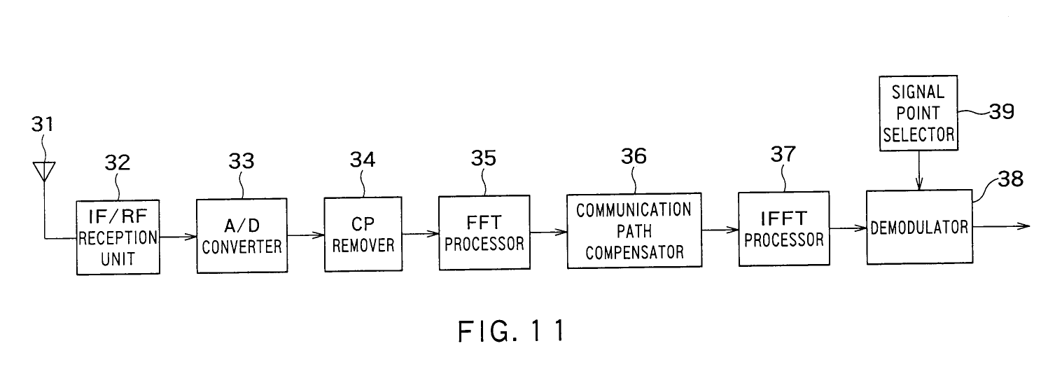

FIG. 11 shows a first embodiment of a single carrier receiver of the present invention. This receiver is intended to receive a transmission signal generated using the first conversion method in the first embodiment and the second embodiment, and the first conversion method in the third embodiment.

A received signal received through an antenna 31 is converted to a baseband signal at an IF/RF reception unit 32 and then converted to a digital signal at an A/D converter 33.

With a sample point of the same time length as that of a cyclic prefix (CP) added at the transmitter removed by a CP remover 34, the digital signal is then subjected to Fourier transform processing with a time length of the data block at FFT (Fast Fourier Transform) processor 35 and converted to a plurality of frequency components (frequency domain data).

The signals of the respective frequency components are multiplied by a complex number for compensating their respective communication channels at a communication channel compensator 36. The complex numbers to be multiplied can be calculated based on MMSE (Minimum-Mean Square Error) equalization and ZF (Zero-Forcing) equalization as typical methods.

The signals of the respective frequency components equalized at the communication channel compensator 36 are converted to a data sequence on the time axis by being subjected to inverse Fourier transform processing by an IFFT (inverse Fast Fourier Transform) processor 37. Suppose the data sequence on the time axis outputted from the IFFT processor 37 and expressed in a unit corresponding to the data block is called a “received data block” here.

A signal point selector 39 instructs a demodulator 38 on a signal point set to be used for each symbol (received data symbol) in the received data block in order to perform demodulation with signal points operated or converted by the transmitter taken into consideration. The demodulator 38 performs data demodulation using the signal point set instructed from the signal point selector 39.

More specifically, as for a received data symbol at the head of a received data block, when the number of symbols of cyclic prefixes (CP) added to the data block is an odd number, an instruction is given to the demodulator 38 to use the same signal point set as that used to demodulate the received data symbol at the end of the immediately preceding received data block and as for the subsequent received data symbols, an instruction is given to the demodulator 38 to ensure that a first symbol signal point set and a second symbol signal point set are arranged alternately as in the case of normal demodulation. On the other hand, when the number of symbols of cyclic prefixes (CP) added to the data block is an even number, an instruction is given to the demodulator 38 to use a signal point set which is different from the signal point set used to demodulate the received data symbol at the end of the immediately preceding received data block for the received data symbol at the head.

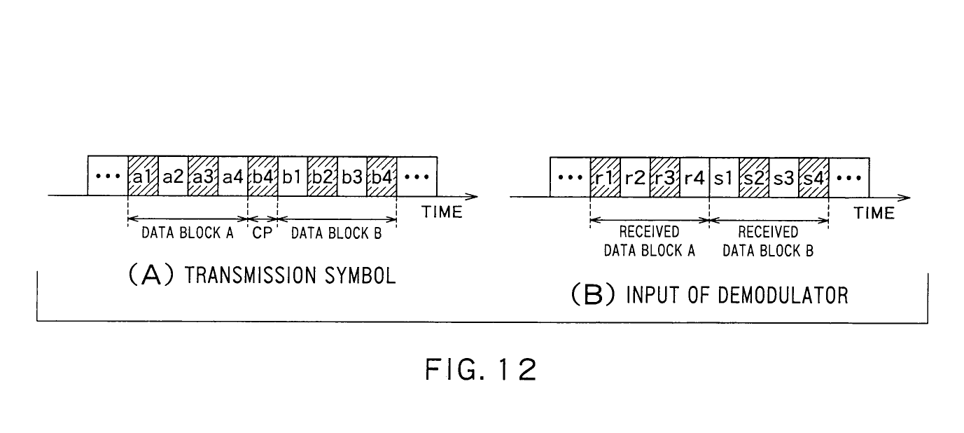

FIG. 12 illustrates operation examples of the signal point selector 39 and the demodulator 38 in FIG. 11. These examples show a case where the number of data symbols included in a data block is an even number and the length of a cyclic prefix added is an odd number.

For example, suppose that two consecutive data blocks transmitted from the transmitter in the first embodiment and the transmitter using the first conversion method in the second and third embodiments are a data block A and a data block B and a cyclic prefix (CP) of one symbol is added to the head of the data block B. The transmission symbols are composed of alternately repeated first symbol signal points (shaded) and second symbol signal points (not shaded) as shown in FIG. 12(A). Therefore, when the receiver removes a cyclic prefix (CP), the second symbol signal point is repeated across the boundary between the received data block A and the received data block B as shown in FIG. 12(B) and the same signal point set as that used to demodulate the symbol at the end of the received data block A is used when the head symbol of the received data block B is demodulated. Received data symbols r1 to r4 correspond to data symbols al to a4 in the data symbol A and received data symbols s1 to s4 correspond to data symbols b1 to b4 in the data symbol B.

Here, the signal point pattern of data symbols transmitted from the transmitter of the first embodiment or the transmitter using the first conversion method of the second and third embodiments has a structure, including a cyclic prefix (CP), whereby first symbol signal points and second symbol signal points are repeated alternately and the number of symbols of cyclic prefixes (CP) added to each data symbol is known to the receiver. Therefore, the pattern of signal point sets to be used for demodulation for each data symbol is also known and it is obvious that by the signal point selector 39 operating according to this pattern, a signal from each of the above described transmitters can be demodulated by the receiver in FIG. 11.

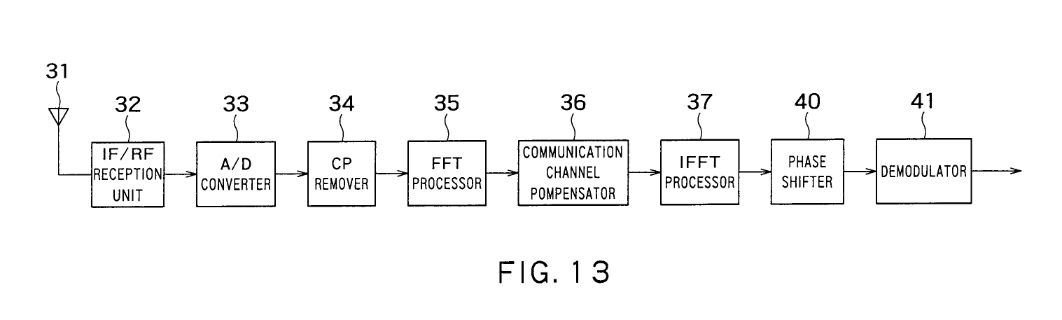

FIG. 13 shows a second embodiment of a single carrier receiver of the present invention. This receiver is intended to receive a transmission signal generated using the second conversion method in the second and third embodiments. The operations of an antenna 31 to an IFFT processor 37 are the same as those in FIG. 11 and explanations thereof will be omitted.

A phase shifter 40 performs phase shift processing of restoring signal points changed by the signal point conversion processors 17, 18 of the transmitter to their original states for the corresponding received data blocks out of the received data blocks outputted from the IFFT processor 37.

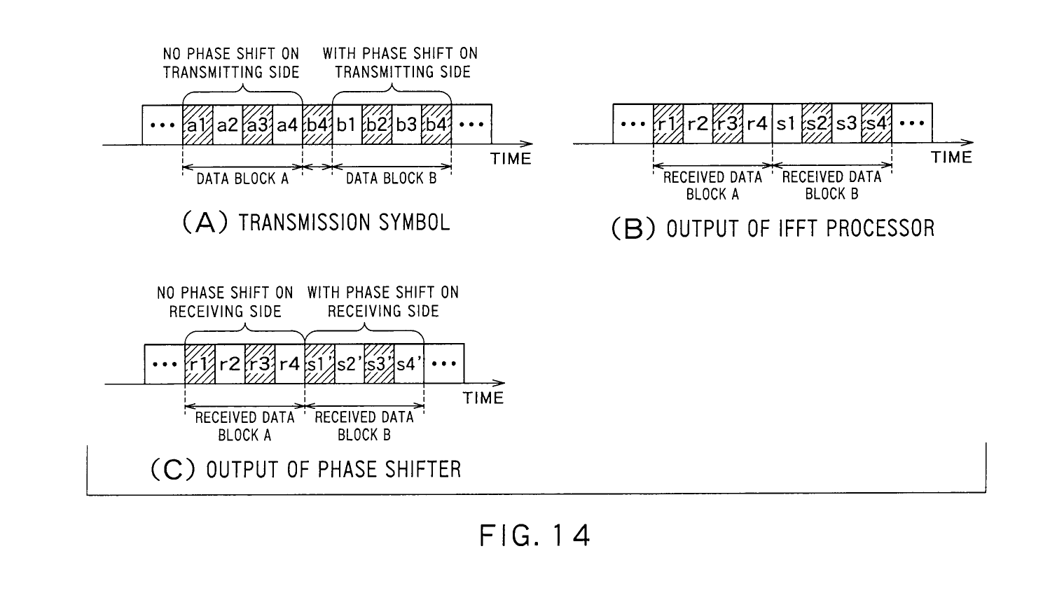

For example, a data block B with a cyclic prefix shown in FIG. 14(A) for which the transmitter has multiplied the whole block by exp(jφ) is rid of the cyclic prefix (CP) as shown in FIG. 14(B), converted to a received data block B and phase shifter 40 multiplies each received data symbol in the received data block B by exp(−jφ) to cancel out exp(jφ) as shown in FIG. 14(C). By carrying out such processing, a demodulator 41 after the phase shifter 40 can demodulate data using first symbol signal point sets and second symbol signal point sets alternately as in the case of a normal demodulation operation.

Here, the pattern of data symbol signal points transmitted from the transmitter using the second conversion method of the second and third embodiments has a structure, including a cyclic prefix (CP), whereby first symbol signal points and second symbol signal points are alternately repeated and the number of symbols of cyclic prefixes (CP) added to each data block is known to the receiver. Therefore, the pattern of appearance of data blocks to which the transmitting side has applied a phase shift is also known and it is obvious that by the phase shifter 40 performing a phase shift so as to cancel out the phase shift according to the appearance pattern, a signal from each transmitter of the second and third embodiments can be demodulated by this receiver. That is, the phase shifter 40 can select a received data block according to a predetermined selection pattern and carry out phase shift processing on the selected received data block.

As described above, using the transmitter according to each of the first to third embodiments makes it possible to avoid passage through a zero point due to a transition between signal points across a boundary between data blocks with cyclic prefixes or data blocks with cyclic postfixes irrespective of the number of symbols of cyclic prefixes added even when applying a modulation scheme using two types of signal point sets such as π/2 shift BPSK modulation or π/4 shift QPSK modulation and realize transmission with high electric power efficiency. Furthermore, using the receiver according to the first and second embodiments allows a signal transmitted from the single carrier transmitter according to each of the first to third embodiments to be demodulated correctly.

The present invention is not limited to the above described embodiments as they are, but can be implemented with components thereof modified in the implementation stage within a range not departing from the essence thereof. Furthermore, various inventions can be formed by appropriately combining a plurality of components disclosed in the above described embodiments. For example, some components may be deleted from all components shown in the embodiments. Moreover, components applicable to different embodiments may also be combined as appropriate.

What is claimed is:

1. A transmitter comprising:
a modulator configured to modulate a data bit sequence by alternately using first and second signal point sets obtained by dividing a signal constellation on an IQ plane to generate a data symbol sequence;
a data block generator configured to generate data blocks each including a plurality of data symbols by dividing the data symbol sequence into a plurality,
an addition unit configured to add a duplicate of one or more data symbols at a head or an end of each data block to the end or the head of each data block as a guard interval (cyclic postfix or cyclic prefix) to generate data blocks with guard intervals;
a transmission unit configured to transmit the data blocks with the guard intervals; and
a controller configured to control modulation by the modulator so that
an end data symbol of a first data block with the guard interval and a head data symbol of a second data block with the guard interval generated following the first data block with the guard interval belong to different signal point sets and
data symbols in the first data block with the guard interval alternately belong to the first and second signal point sets and data symbols in the second data block with the guard interval alternately belong to the first and second signal point sets.

2. The transmitter according to claim 1, wherein the controller instructs the modulator to use same signal point set as the signal point set used for data bits corresponding to the end data symbol of a third data block generated preceding the first data block for data bits corresponding to the head data symbol of the first data block when a symbol number of data symbols included in the first data block is an even number and a symbol number of data symbols included in the guard interval is an odd number.

3. The transmitter according to claim 1, wherein the modulator modulates the data bit sequence using a π/2 shift BPSK modulation scheme or a π/4 shift QPSK modulation scheme.

4. A transmitter comprising:
a modulator configured to modulate a data bit sequence by alternately using first and second signal point sets obtained by dividing a signal constellation on an IQ plane to generate a data symbol sequence;
a data block generator configured to generate data blocks each including a plurality of data symbols by dividing the data symbol sequence into a plurality,
a signal point conversion processor configured to
select a data block to be subjected to signal point conversion processing of converting the data symbols in the data block to signal points in a different signal point sets from the signal point sets that has used in the modulator and
perform the signal point conversion processing on a selected data block;
an addition unit configured to add a duplicate of one or more data symbols at a head or an end of each data block which is subjected or is not subjected to the signal point conversion processing to the end or the head of each data block as a guard interval (cyclic postfix or cyclic prefix) to thereby generate data blocks with guard intervals; and
a transmission unit configured to transmit the data blocks with guard intervals,
wherein the signal point conversion processor selects a first data block as a data block to perform the signal point conversion processing when a head data symbol of the first data block with the guard interval belongs to same signal point set as that of an end data symbol of a second data block with the guard interval generated preceding the first data block with the guard interval if the first data block is not subjected to the signal point conversion processing.

5. The transmitter according to claim 4, wherein the signal point conversion processor selects the first data block as a data block to perform the signal point conversion processing when the head data symbol of the first data block belongs to a different signal point set from that of the end data symbol of the second data block and a symbol number of data symbols included in the guard interval is an odd number.

6. The transmitter according to claim 4, wherein the signal point conversion processor selects the first data block as a data block to perform the signal point conversion processing when the head data symbol of the first data block belongs to same signal point set as that of the end data symbol of the second data block and a symbol number of data symbols included in the guard interval is an even number.

7. The transmitter according to claim 4, wherein the modulator modulates the data bit sequence using a π/2 shift BPSK modulation scheme or a π/4 shift QPSK modulation scheme.

8. A transmitter comprising:
a modulator configured to modulate a data bit sequence by alternately using first and second signal point sets obtained by dividing a signal constellation on an IQ plane to generate a data symbol sequence;
a data block generator configured to generate data blocks each including a plurality of data symbols by dividing the data symbol sequence into a plurality,
an addition unit configured to add a duplicate of one or more data symbols at a head or an end of each data block to the end or the head of each data block as a guard interval (cyclic postfix or cyclic prefix) to generate data blocks with guard intervals; and
a signal point conversion processor configured to
select a data block with the guard interval to be subjected to signal point conversion processing of converting the data symbols in the data block with the guard interval to signal points in different signal point sets from the signal point sets that has used in the modulator and
perform the signal point conversion processing on a selected data block with the guard interval;
a transmission unit configured to transmit the data blocks with the guard intervals which is subjected or is not subjected to the signal point conversion processing,
wherein the signal point conversion processor selects a first data block with the guard interval as a data block with the guard interval to perform the signal point conversion processing when a head data symbol of the first data block with the guard interval belongs to same signal point set as that of an end data symbol of a second data block with the guard interval generated preceding the first data block with the guard interval.

9. The transmitter according to claim 8, wherein the modulator modulates the data bit sequence using a π/2 shift BPSK modulation scheme or a π/4 shift QPSK modulation scheme.

10. A receiver comprising:
a reception unit configured to receive data blocks with guard intervals (cyclic prefixes or cyclic postfixes), each data block with guard interval including a plurality of data symbols;
an remover configured to remove the guard intervals from the data blocks with the guard intervals to extract the data blocks; and
a demodulator configured to demodulate data symbols included in each data block by alternately using two signal point sets obtained by dividing a signal constellation on an IQ plane,
wherein the demodulator uses same signal point set as the signal point set used for an end data symbol of a third data block preceding a fourth data block, for the head data symbol of the fourth data block when a symbol number of data symbols included in the guard interval is an odd number.

11. A receiver comprising:
a reception unit configured to receive data blocks with guard intervals (cyclic prefixes or cyclic postfixes), each data block with the guard interval including a plurality of data symbols;
an remover configured to remove the guard intervals from the data blocks with the guard intervals to extract the data blocks;
a phase shifter configured to perform a phase shift on data symbols included in selection data blocks selected according to a predetermined selection pattern from among the data blocks; and
a demodulator configured to demodulate data symbols included in each data block which is subjected or is not subjected to the phase shift by the phase shifter, by alternately using two signal point sets obtained by dividing a signal constellation on an IQ plane.
